(19) United States
(12) Patent Application Publication
(10) Pub. No.: US 2025/0300292 A1
(43) Pub. Date: Sep. 25, 2025

(54) Swappable battery pack for refrigerated container

(71) Applicant: ADDVOLT, S.A., São Mamede de Infesta (PT)

(72) Inventors: José Ricardo Sousa Silva Soares, São Mamede de Infesta (PT); Bruno Filipe Azevedo Costa, São Mamede de Infesta (PT); Luís Filipe Costa Luís Cardoso Encerrabodes, São Mamede de Infesta (PT); João Paulo Sousa Magalhães, São Mamede de Infesta (PT); Ricardo Abílio Leite Falcão Correia Gonçalves, São Mamede de Infesta (PT)

(73) Assignee: ADDVOLT, S.A., São Mamede de Infesta (PT)

(21) Appl. No.: 19/072,453

(22) Filed: Mar. 6, 2025

(30) Foreign Application Priority Data
Mar. 6, 2024 (PT) 119305
Jul. 24, 2024 (PT) 119616

(51) Int. Cl. H01M 50/244; B60H 1/00; B60P 3/20; H01M 10/42; H01M 10/658; H01M 50/249

(52) U.S. Cl. CPC H01M 50/244; B60H 1/00428; B60P 3/20; H01M 10/4257; H01M 10/658; H01M 50/249

(57) ABSTRACT

A swappable battery pack configured to power a refrigeration unit of a refrigerated vehicle or cargo container which offers a flexible and efficient solution for electrical power of refrigeration units of cooling containers or vehicles transporting temperature-sensitive cargo. By equipping such a container with a swappable battery pack, preferably further having a temperature control software component, remote management capabilities, and predictive algorithms, a refrigeration system can ensure optimal cooling performance, operational flexibility, and cargo preservation during transportation.

### CROSS-REFERENCE

This application claims the benefit of priority under 35 U.S.C. § 119(e) from Portugal Patent Application No. 119305, filed on Mar. 6, 2024 and Portugal Patent Application No. 119616, filed Jul. 24, 2024, which are hereby incorporated by reference as if set forth in their entirety herein.

### TECHNICAL FIELD

The disclosure relates to a swappable battery pack for powering a refrigeration unit for cooling the interior refrigerated vehicle or cargo container, i.e. a refrigerated shipping container or a container of refrigerated vehicle, and relates to a container comprising the swappable battery pack. The disclosure includes related software and methods for deploying and managing the swappable battery pack.

### BACKGROUND

Refrigeration units are essential for maintaining temperature-sensitive cargo during transportation. However, traditional refrigeration systems integrated into trailers or vehicles often lack flexibility and require significant downtime for maintenance or replacement. These systems typically require electrical power generators that use of a combustion engine. Refrigeration units may be powered electrically by batteries but in existing refrigerated containers or refrigerated vehicles there is no adequate space and mounting solutions for receiving batteries.

There is thus a need for a more efficient and adaptable solution that allows for quick deployment and management of electrical power delivery to refrigeration units of to ensure uninterrupted cooling of cargo.

These facts are disclosed in order to illustrate the technical problem addressed by the present disclosure.

### GENERAL DESCRIPTION

The present disclosure relates to a swappable battery pack for powering a refrigeration unit of a refrigerated vehicle or cargo container which offers a flexible and efficient solution for electrical power of refrigeration units of cooling containers or vehicles transporting temperature-sensitive cargo. With the disclosed swappable battery pack, preferably with temperature control software, remote management capabilities, and predictive algorithms, a refrigeration system can ensure optimal cooling performance, operational flexibility, and cargo preservation during transportation.

The present disclosure relates to a swappable battery pack for refrigeration units and respective container disclosed herein which address the aforementioned challenges by providing a modular and scalable solution for cooling trailers or vehicles. The system comprises a swappable battery pack that can be easily installed and replaced as needed, minimizing downtime, and maximizing operational efficiency. Additionally, the swappable battery pack may include a system comprising software for deploying and managing these units effectively, ensuring optimal cooling performance and temperature control for various cargo types.

The swappable battery pack of the present disclosure and respective management system are suitable for various industries requiring temperature-controlled transportation, including food and beverage, pharmaceuticals, and perishable goods. The disclosure can be deployed in trailers, trucks, vans, and other vehicles involved in the transportation of temperature-sensitive cargo.

The present disclosure to swappable battery pack enables quick deployment and replacement, allowing for seamless cooling of cargo without interrupting operations. Additionally, a swappable battery pack can be swapped out for charging and allowing for a fully charged battery pack to be swapped in, enabling quick deployment and replacement, allowing for seamless cooling of cargo without interrupting operations.

An aspect of the present disclosure relates to a swappable battery pack for powering a refrigeration unit of a refrigerated vehicle container or a refrigerated cargo container, and the swappable battery pack being for mounting inside said refrigerated container, the swappable battery pack comprising one or more batteries, and one or more mounting attachments for attaching to the inside of the refrigerated container.

In an embodiment for better results, the mounting attachments are releasable.

In an embodiment for better results, the one or more mounting attachments are one or more laterally retractable mounting attachments for wedge-mounting the swappable battery pack within the refrigerated container.

In an embodiment for better results, the one or more mounting attachments are one or more laterally retractable mounting attachments for coupling to an internal lashing point or internal stowage stopper of the refrigerated container.

In an embodiment for better results, the one or more mounting attachments are one or more laterally retractable mounting attachments for coupling between internal stopper protrusions of the refrigerated container.

In an embodiment for better results, the mounting attachments comprise one or more laterally retractable clamping-lock bars; the clamping-lock bars are preferably arranged vertically along the lateral sides of the swappable battery pack.

In an embodiment for better results, one or more retractable safety feet arranged to, when extended, stand the swappable battery pack, i.e. to maintain an upright position of swappable battery pack.

In an embodiment for better results, the one or more retractable safety feet each comprise, preferably at their end, a guiding wheel mounted to turn around a vertical axis.

In an embodiment for better results, the swappable battery pack may further comprise a frame for holding the one or more batteries, and for holding an electronic control circuit for managing the one or more batteries, in particular the frame being a cage for holding within said cage the one or more batteries, and the electronic control circuit, in particular the electronic control circuit comprising power electronics for managing refrigeration electric power delivered from the one or more batteries and for managing charging electric power delivered to the one or more batteries.

In an embodiment for better results, the one or more batteries are arranged vertically below the electronic control circuit.

In an embodiment for better results, the swappable battery pack may comprise a battery compartment containing the one or more batteries and an electronics compartment containing the electronic control circuit, in particular the battery compartment being arranged vertically below the electronics compartment.

In an embodiment for better results, the swappable battery pack may comprise a lifting fork positioner for receiving a lifting fork for lifting the swappable battery pack.

In an embodiment for better results, the swappable battery pack is integrally mounted with and within a framework of the refrigerated container.

In an embodiment for better results, the swappable battery pack is arranged to be mounted below a recess of the refrigerated container, where the recess is arranged to receive the refrigeration unit of the refrigerated container.

In an embodiment for better results, the swappable battery pack is laterally dimensioned to fit laterally within an internal width of a standard refrigerated container and vertically dimensioned to fit vertically within an internal height of said recess of a standard refrigerated container.

In an embodiment for better results, the swappable battery pack may comprise a thermal insulation division wall arranged to insulate the swappable battery pack from the refrigerated internal volume of the refrigerated container.

In an embodiment for better results, the thermal insulation division wall is arranged to insulate the swappable battery pack from the refrigerated internal volume of the refrigerated container when the swappable battery pack is mounted inside the refrigerated container.

In an embodiment for better results, the thermal insulation division wall is arranged on a frontal surface of the swappable battery pack and a back surface of the swappable battery pack is arranged to be mounted to a wall of the refrigerated container.

Another aspect of the present disclosure relates to a container comprising a swappable battery pack of the present disclosure.

In an embodiment for better results, the inside of the refrigerated container comprises anchoring attachments for receiving the one or more mounting attachments.

In an embodiment for better results, the container may comprise one or more longitudinal anchoring profiles for receiving the one or more mounting attachments.

In an embodiment for better results, the container may comprise a refrigeration unit for refrigerating the container.

In an embodiment for better results, the refrigeration unit is mounted externally, i.e. mounted to the outside, to the container, in particular mounted in a recess of the container.

In an embodiment for better results, the container is a reefer container, i.e. a refrigerated intermodal freight container, also called a refrigerated shipping container or refrigerated ISO Container.

In an embodiment for better results, the container is a reefer truck, i.e. a refrigerated vehicle container, i.e. a vehicle comprising an integrally mounted refrigerated container, also called a refrigerated vehicle.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function, or which is adapted or configured to provide that function.

Where elements are described as being connected or connectable, they may be directly connected. Where elements are described as being coupled or coupleable, they may be linked by one or more intervening or interposing elements.

### BRIEF DESCRIPTION OF THE DRAWINGS

The following figures provide preferred embodiments for illustrating the disclosure and should not be seen as limiting the scope of invention.

FIG. 1: Schematic representation of an embodiment of a frontal view of the swappable battery pack of the present disclosure.

FIG. 2: Schematic representations of an embodiment of a lateral view of the swappable battery pack of the present disclosure.

FIG. 3: Schematic representation of an embodiment of a top view of the swappable battery pack of the present disclosure.

FIG. 4: Schematic representation of an embodiment of a bottom view of the swappable battery pack of the present disclosure.

FIG. 5: Schematic representation of an embodiment of a frontal view of the swappable battery pack of the present disclosure.

FIG. 6: Schematic representation of an embodiment of a perspective view of the swappable battery pack of the present disclosure.

FIG. 7: Schematic representation of an embodiment of a lateral view of the swappable battery pack of the present disclosure.

FIG. 8: Schematic representation of an inside view of a refrigerated container and an embodiment of the swappable battery pack of the present disclosure.

FIG. 9: Schematic representation of a lateral view of a refrigerated container and an embodiment of the swappable battery pack of the present disclosure.

FIG. 10: Schematic representation of an external view of a refrigerated container and an embodiment of the swappable battery pack of the present disclosure.

FIGS. 11A, 11B and 11C: Schematic representations of a lower portion of an embodiment of the swappable battery pack of the present disclosure, including a bottom view in FIG. 11A, a side view in FIG. 11B and a top view in FIG. 11, where the retractable safety feet are retracted within the lower portion of the swappable battery pack.

FIG. 12: Schematic representation of a lower portion of an embodiment of the swappable battery pack of the present disclosure, including a side view where the retractable safety feet are extended.

FIGS. 13A and 13B: Schematic representations of a lower portion of an embodiment of the swappable battery pack of the present disclosure showing the offset supports of the clamping-lock bars, in both top and bottom views.

FIG. 14: Schematic representation of an embodiment of a release mechanism for extension of the retractable safety feet.

FIG. 15: Schematic representation of a detail of an embodiment of the release mechanism for extension of the retractable safety feet.

FIG. 16: Schematic representation of a detail of fixation bolts of an embodiment of the swappable battery pack.

FIGS. 17A and 17B: Schematic representations of an embodiment with extendable supports of the clamping-lock bars, shown in a retracted position in FIG. 17A and in an extended position in FIG. 17B.

FIG. 18A and 18B: Schematic representation of a front (FIG. 18A) and perspective (FIG. 18B) views of cross-section of the refrigerated container and an embodiment of the swappable battery pack with clamps coupled to clamping rails of the container.

### DETAILED DESCRIPTION

The present disclosure relates to a swappable battery pack for powering a refrigeration unit of a refrigerated vehicle or cargo container which offers a flexible and efficient solution for electrical power of refrigeration units of cooling containers or vehicles transporting temperature-sensitive cargo. With the disclosed swappable battery pack, preferably with temperature control software, remote management capabilities, and predictive algorithms, a refrigeration system can ensure optimal cooling performance, operational flexibility, and cargo preservation during transportation.

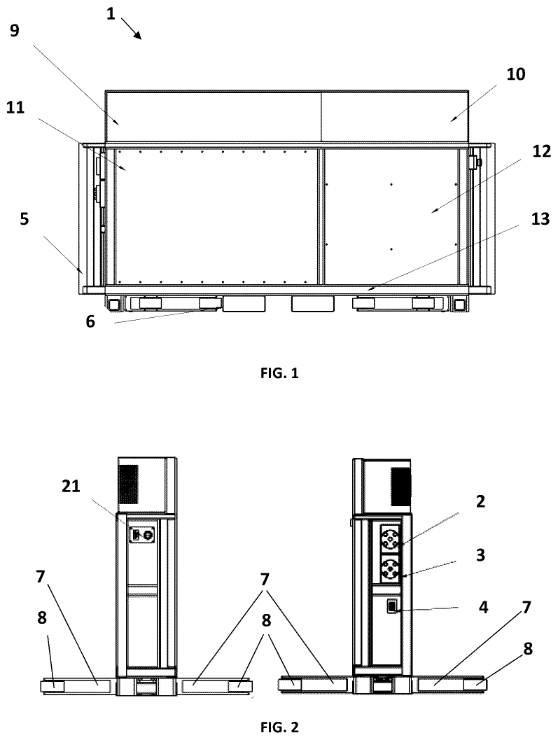

FIG. 1 shows a schematic representation of an embodiment of a view of the swappable battery pack of the present disclosure, where (1) represents the swappable battery pack, (5) represents a clamping-lock bar, (6) represents lifting fork positioners; (9) represents power electronics left compartment; (10) represents power electronics right compartment; (11) represents battery left compartment; (12) represents battery right compartment; (13) represents add swap cage.

FIG. 2 shows a schematic representation of an embodiment of a view of the swappable battery pack of the present disclosure, wherein (21) represents the service disconnect; (2) represents female power connector-reefer; (3) represents male power connector-charging; (4) represents signal connector; 7) represents retractable safety feet; and (8) represents guiding wheels.

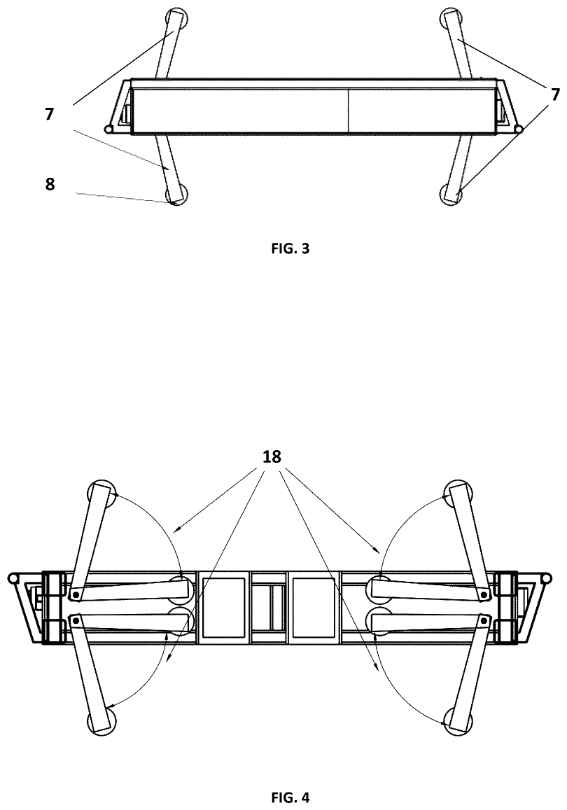

FIG. 3 shows a schematic representation of an embodiment of a view of the swappable battery pack of the present disclosure, wherein (7) represents retractable safety feet; (8) represents guiding wheel.

FIG. 4 shows a schematic representation of an embodiment of a view of the swappable battery pack of the present disclosure, wherein (18) represents rotation arcs of the retractable safety feet and respective guiding wheels.

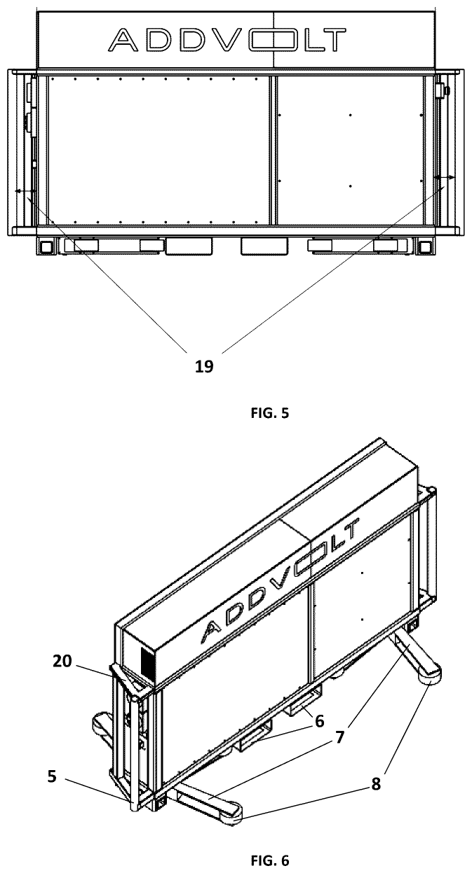

FIG. 5 shows a schematic representation of an embodiment of a view of the swappable battery pack of the present disclosure, where (19) represents retractable clamping-lock bars.

FIG. 6 shows a schematic representation of an embodiment of a view of the swappable battery pack of the present disclosure, where (20) represents an offset support of the clamping-lock bar.

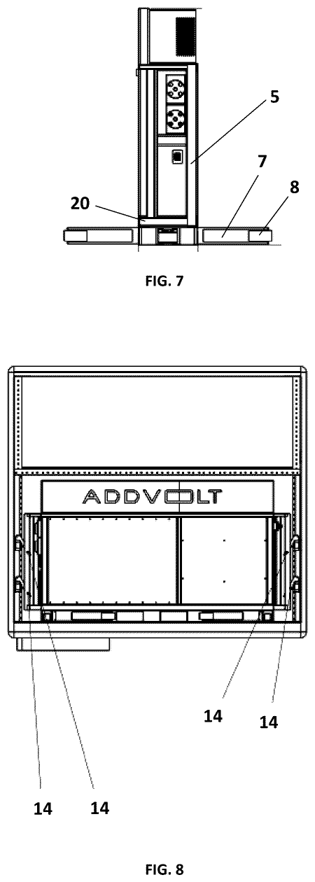

FIG. 7 shows a schematic representation of an embodiment of a view of the swappable battery pack of the present disclosure where the offset supports (20) allow for the unimpeded access of a lateral face of the swappable battery pack.

FIG. 8 shows a schematic representation of an embodiment of a view of the swappable battery pack of the present disclosure wherein (14) represents the clamp mechanism.

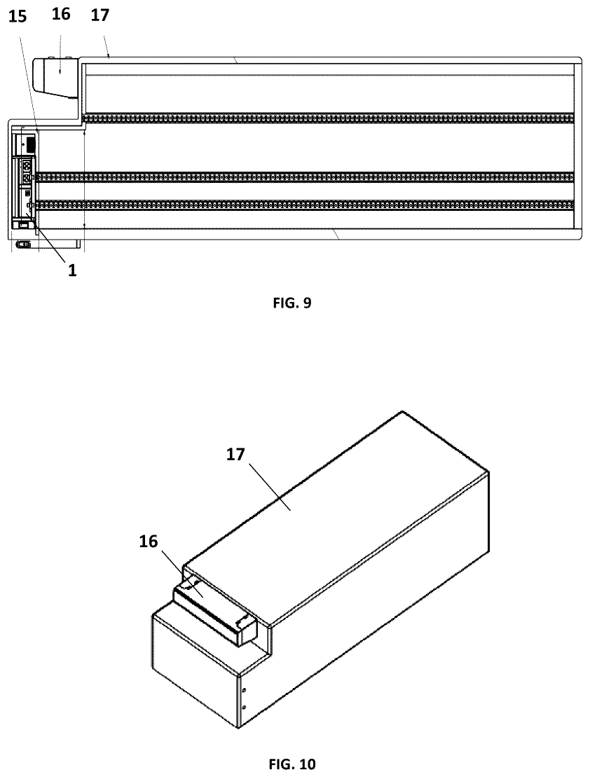

FIG. 9 shows a schematic representation of an embodiment of a view of the swappable battery pack of the present disclosure; wherein (15) represents the thermal insulation/division wall; wherein (16) represents reefer unit; wherein (17) represents the refrigerated container.

FIG. 10 shows a schematic representation of an embodiment of a view of the refrigerated container.

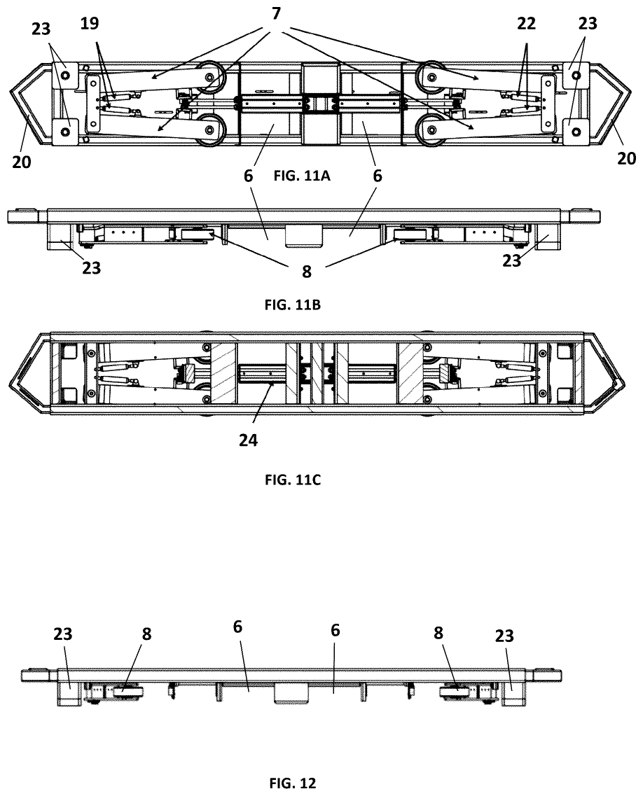

FIGS. 11A, 11B and 11C shows a schematic representation of a lower portion of an embodiment of the swappable battery pack of the present disclosure, showing a release mechanism 24 for extension of the retractable safety feet, including a bottom view FIG. 11A, a side view FIG. 11B and a top view FIG. 11C, where the retractable safety feet are retracted within the lower portion of the swappable battery pack.

FIG. 12 shows a schematic representation of a lower portion of an embodiment of the swappable battery pack of the present disclosure, including a side view where the retractable safety feet and respective guiding wheels (8) are extended. Support feet (23) and the lifting fork positioners (6) are also shown.

FIGS. 13A and 13B show a schematic representation of a lower portion of an embodiment of the swappable battery pack of the present disclosure also showing the offset supports (20) of the clamping-lock bars, illustrating top and bottom views.

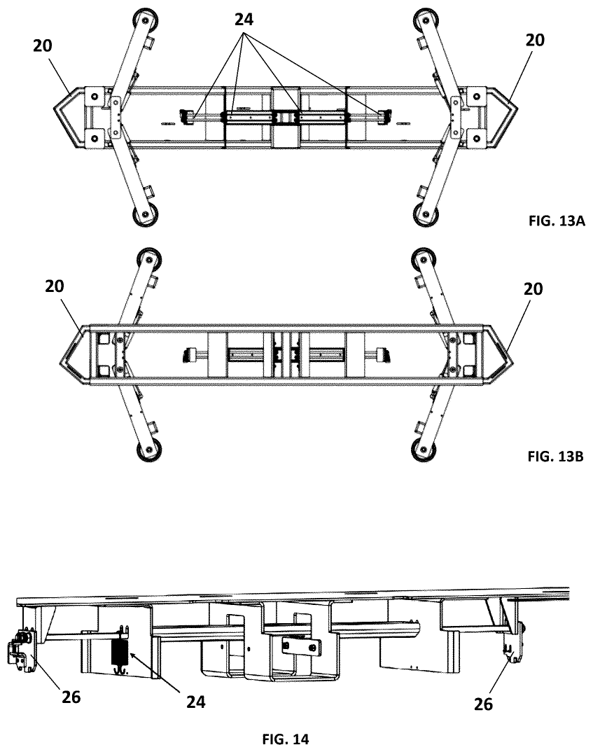

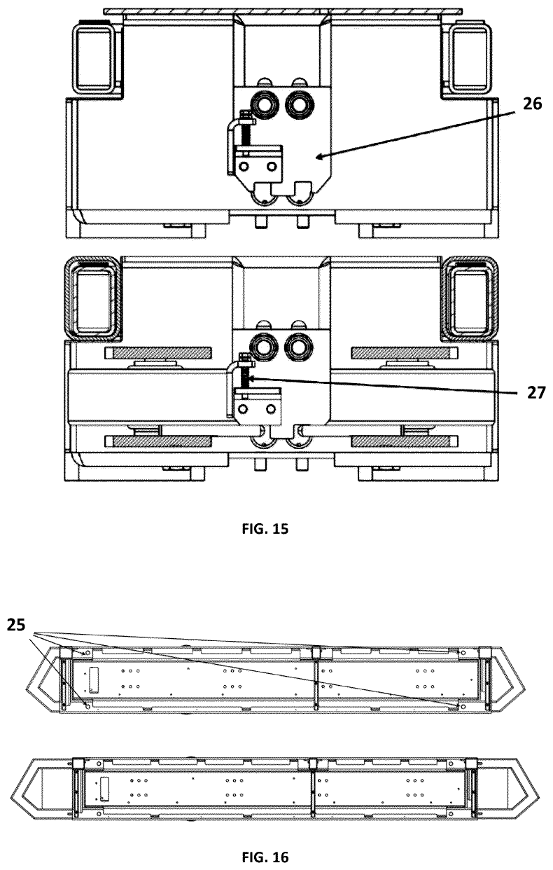

FIG. 14 shows a schematic representation of an embodiment of a release mechanism (24) for extension of the retractable safety feet and corresponding release plate (26) of the release mechanism.

FIG. 15 shows a schematic representation of a detail of an embodiment of the release mechanism for extension of the retractable safety feet, further showing a spring (27) of the release mechanism.

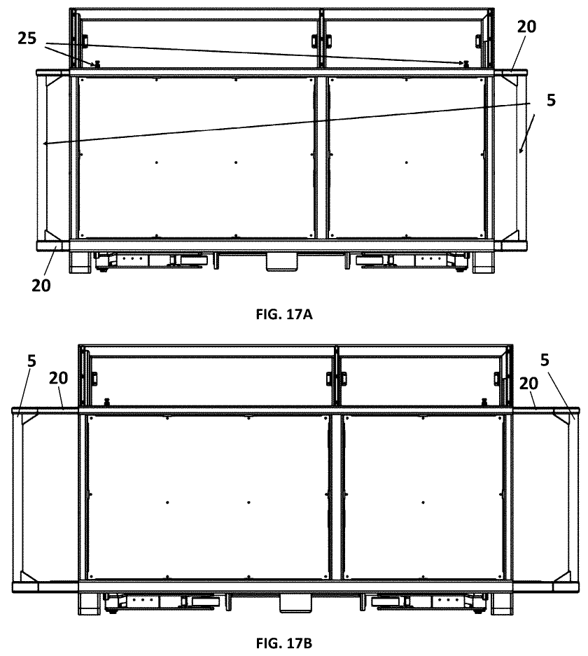

FIG. 16 shows a schematic representation of a detail of fixation bolts of an embodiment of the swappable battery pack further showing fixing bolts (25).

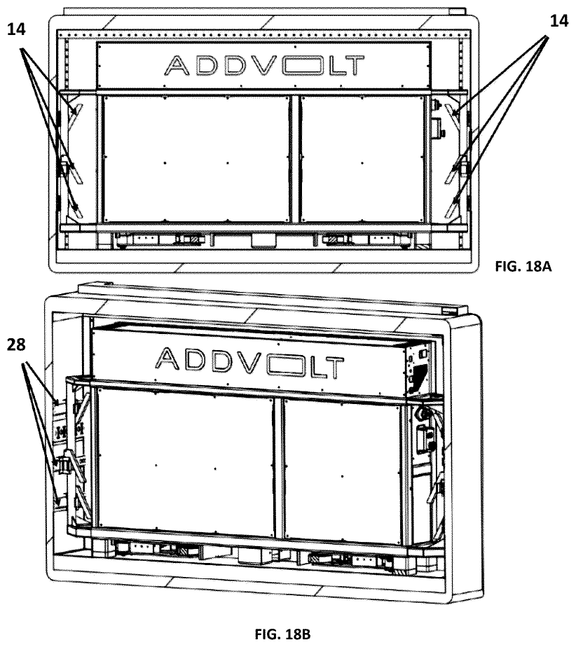

FIGS. 17A and 17B show a schematic representation of an embodiment with extendable supports of the clamping-lock bars.

FIGS. 18A and 18B show a schematic representation of a front and perspective views of cross-section of the refrigerated container and an embodiment of the swappable battery pack with clamps (14) coupled to clamping rails (28) of the container.

Features present in the drawings:
(1) represents a swappable battery pack for a refrigerated container;
(2) represents a female power reefer connector;
(3) represents a male power charging connector;
(4) represents signal connector;
(5) represents a clamping-lock bar;
(6) represents lifting fork positioners;
(7) represents retractable safety feet;
(8) represents a guiding wheel of a retractable safety foot.
(9) represents a power electronics left compartment;
(10) represents a power electronics right compartment;
(11) represents a battery left compartment;
(12) represents a battery right compartment;
(13) represents a swappable battery pack cage;
(14) represents a clamp;
(15) represents a thermal insulation/division wall;
(16) represents a reefer (refrigerating device);
(17) represents a container body;
(18) represents rotation arcs of the retractable safety feet;
(19) represents retractable clamping-lock bars;
(20) represents an offset support of the clamping-lock bar;
(21) represents a service disconnect input (e.g. a button)
(22) represents extension springs of the retractable safety feet;
(23) represents static feet of the swappable battery pack;
(24) represents a release mechanism for extension of the retractable safety feet;
(25) represents fixing bolts;
(26) represents release plate of the release mechanism;
(27) represents a spring of the release mechanism; and
(28) represents clamping rails of the refrigerated container.

The term “comprising” whenever used in this document is intended to indicate the presence of stated features, integers, steps, components, but not to preclude the presence or addition of one or more other features, integers, steps, components or groups thereof.

It is to be appreciated that certain embodiments of the disclosure as described herein may be incorporated as code (e.g., a software algorithm or program) residing in firmware and/or on computer useable medium having control logic for enabling execution on a computer system having a computer processor, such as any of the servers described herein. Such a computer system typically includes memory storage configured to provide output from execution of the code which configures a processor in accordance with the execution. The code can be arranged as firmware or software, and can be organized as a set of modules, including the various modules and algorithms described herein, such as discrete code modules, function calls, procedure calls or objects in an object-oriented programming environment. If implemented using modules, the code can comprise a single module or a plurality of modules that operate in cooperation with one another to configure the machine in which it is executed to perform the associated functions, as described herein.

The disclosure should not be seen in any way restricted to the embodiments described and a person with ordinary skill in the art will foresee many possibilities to modifications thereof. The above-described embodiments are combinable. The following claims further set out particular embodiments of the disclosure.

1. A Swappable battery pack for powering a refrigeration unit of a refrigerated vehicle or cargo container and for mounting inside said refrigerated container, comprising one or more batteries, and one or more mounting attachments arranged to be attached to the inside of the refrigerated container.

2. The swappable battery pack according to claim 1, wherein the mounting attachments are releasable.

3. The swappable battery pack according to claim 1, wherein the one or more mounting attachments are one or more laterally retractable mounting attachments.

4. The swappable battery pack according to claim 3, wherein the one or more mounting attachments are one or more laterally retractable mounting attachments configured to wedge-mount the swappable battery pack within the refrigerated container, or wherein the one or more mounting attachments are one or more laterally retractable mounting attachments configured to couple to an internal lashing point or internal stowage stopper of the refrigerated container or to couple to one or more longitudinal internal anchoring profiles of the refrigerated container.

5. The swappable battery pack according to claim 4, wherein the one or more mounting attachments are one or more laterally retractable mounting attachments configured to couple between internal stopper protrusions of the refrigerated container, said internal stopper protrusions being comprised in one or more clamping rails of the refrigerated container.

6. The swappable battery pack according claim 1, wherein the mounting attachments comprise one or more laterally retractable clamping-lock bars, and further comprising a telescopically-extendable support for each of the one or more laterally retractable clamping-lock bars.

7. The swappable battery pack according to claim 1, further comprising one or more retractable safety feet arranged to, when extended, stand the swappable battery pack so as to maintain an upright position of swappable battery pack

8. The swappable battery pack according to claim 1, further comprising a frame configured to hold the one or more batteries, and to hold an electronic control circuit for managing the one or more batteries, the frame being a cage shaped to hold within said cage the one or more batteries, and the electronic control circuit, the electronic control circuit comprising power electronics configured to manage a refrigeration electric power delivered from the one or more batteries and to manage charging electric power delivered to the one or more batteries.

9. The swappable pack according to claim 8, wherein the one or more batteries are arranged vertically below the electronic control circuit, and further comprising a battery compartment containing the one or more batteries and an electronics compartment containing the electronic control circuit, wherein the battery compartment is arranged vertically below the electronics compartment.

10. The swappable battery pack according to claim 1, further comprising lifting fork positioners positioned to receive a lifting fork that lifts the swappable battery pack.

11. The swappable battery pack according to claim 10, further comprising a mechanism configured to extend the retractable safety feet when a lifting fork engages with the lifting fork positioners, or further comprising a mechanism configured to extend the retractable safety feet when a lifting fork engages with the lifting fork positioners and, subsequently, the support feet engage with a floor by the weight of the swappable battery pack.

12. The swappable battery pack according to claim 1, wherein the swappable battery pack is integrally mounted with and within a framework of the refrigerated container.

13. The swappable battery pack according to claim 1, wherein the swappable battery pack is arranged to be mounted below a recess of the refrigerated container, wherein the recess is arranged to receive the refrigeration unit of the refrigerated container, and wherein the swappable battery pack is laterally dimensioned to fit laterally within an internal width of a standard refrigerated container and vertically dimensioned to fit vertically within an internal height of said recess of a standard refrigerated container.

14. The swappable battery pack according to claim 1, further comprising a thermal insulation division wall arranged to insulate the swappable battery pack from the refrigerated internal volume of the refrigerated container.

15. The swappable battery pack according to claim 14, wherein the thermal insulation division wall is arranged to insulate the swappable battery pack from the refrigerated internal volume of the refrigerated container when the swappable battery pack is mounted inside the refrigerated container.

16. The swappable battery pack according to claim 15, wherein the thermal insulation division wall is arranged on a frontal surface of the swappable battery pack and a back surface of the swappable battery pack is arranged to be mounted to a wall of the refrigerated container.

17. A refrigerated container having a swappable battery pack, comprising:
a container;
a refrigeration unit within the container;
one or more batteries;
a mount within the refrigerated container having one or more mounting attachments, wherein the mount is arranged to be attached to the inside of the refrigerated container.

18. The container according to claim 17, wherein the inside of the refrigerated container comprises anchoring attachments configured to receive the one or more mounting attachments, and comprising one or more longitudinal anchoring profiles configured to receive the one or more mounting attachments.

19. The container according to claim 17, further comprising a refrigeration unit configured to refrigerate the container, wherein the refrigeration unit is mounted on the outside of the container in a recess in an external surface of the container.

20. The container according to claim 17, wherein the container is a reefer container, or wherein the container is a reefer truck.
